(19) United States
(12) Patent Application Publication
(10) Pub. No.: US 2005/0271365 A1
(43) Pub. Date: Dec. 8, 2005

(54) Simultaneous video recording processing method of copy-protected contents and video apparatus therefor

(75) Inventor: Shuichi Hisatomi, Fuchu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/142,667

(22) Filed: Jun. 2, 2005

(30) Foreign Application Priority Data
Jun. 8, 2004 (JP) 2004-170431

(51) Int. Cl. H04N 5/76; G11B 15/04; G11B 19/04; H04N 5/91; H04N 7/167

(52) U.S. Cl. 386/94; 360/60; 380/201

(57) ABSTRACT

When a single video recorder having a simultaneous video recording function simultaneously records one or more contents on one or more recording media (HDD/optical disc/semiconductor memory), it is checked if one or more contents are copy-protected. If none of these contents are copy-protected (copy free), simultaneous video recording of these contents is executed. However, if one or more contents are copy-once contents, two or more copies of these copy-once contents are inhibited from being simultaneously recorded (irrespective of their identity).

### CROSS-REFERENCE TO RELATED APPLICATIONS

This application is based upon and claims the benefit of priority from prior Japanese Patent Application No. 2004-170431, filed Jun. 8, 2004, the entire contents of which are incorporated herein by reference.

### BACKGROUND OF THE INVENTION

1. Field of the Invention

The present invention relates to a simultaneous video recording processing method of a plurality of copy-protected contents, and a video apparatus for simultaneously recording a plurality of copy-protected contents in accordance with conditions.

2. Description of the Related Art

In recent years, digital video recorders based on the DVD-video recording (DVD-VR) standard have been developed, and have rapidly prevailed owing to their high quality, convenience, easy access features, and the like. Especially, a DVD/HDD video recorder which has a large-capacity hard disk drive (HDD) as a recording medium in addition to an optical disc based on the DVD standard (see Jpn. Pat. Appln. KOKAI Publication No. 2003-224813) enjoys reputation due to its high functionality.

In this way, in a video recorder which has two different types of recording media (optical disc and HDD), the following usage is available: one content is simultaneously recorded on respective media, two contents are independently and simultaneously recorded on respective media, and two contents are simultaneously recorded on one recording medium (e.g., HDD or the like). Copy-free contents are free from any problem upon simultaneous video recording. However, simultaneous video recording of copy-protected contents poses a problem.

That is, as for copies of contents distributed by terrestrial digital broadcasting, satellite digital broadcasting, pay cable TV, and the like, a copy generation management system using a video signal that permits to form only one copy is defined by EIAJ or the like, and is prevalently used. In a digital recording apparatus that supports this copy generation management system, when the contents of a content to be recorded are “copy once”, they are managed such that a medium used in recording is scrambled, and re-copy to another recording medium is inhibited (that is, a recording medium of a copy-once content generated from a single recording apparatus is always limited to one).

In case of a recording apparatus which has a function of simultaneously recording two contents, an external apparatus can simultaneously record identical broadcasting contents (single content) on a single recording medium using this apparatus. In such case, two or more copy-once contents may be recorded on a single medium, and it is equivalent that a copy-once content (a content which cannot be copied from its copy once it is copied) is copied twice. For example, when copy-once program Pa of terrestrial digital broadcasting from a built-in tuner is to be recorded on an HDD by a DVD/HDD video recorder, if copy-once program Pa from an external tuner can be recorded on that HDD via a line input or the like, two copies of copy-once program Pa, only one copy of which is to be generated by video recording using a single recording apparatus, are present.

Normally, each digital recording apparatus that supports the copy generation management system must pay compensation for the copyrights. For this reason, when broadcasted copy-once program Pa is independently recorded using two recording apparatuses that have independently paid compensation, two recording media of copy-once program Pa can be present. However, a problem is posed when two copies of copy-once program Pa can be recorded by one recording apparatus (that has paid compensation for only one apparatus). Especially, when one or both of the two copies of recorded copy-once program can be moved to another recording medium, two recording media of a copy-once content generated from the single recording apparatus are present, thus disturbing the copyright protection function based on the copy generation management system.

### BRIEF SUMMARY OF THE INVENTION

A simultaneous video recording processing method of copy-protected contents according to an embodiment of the present invention is used when a video apparatus having a simultaneous video recording function simultaneously records a plurality of identical or different contents on one or more recording media (HDD/optical disc). With this method, whether or not each of the plurality of contents is copy-protected is checked. If none of the plurality of contents are copy-protected (copy-free), simultaneous video recording of the plurality of contents is executed. However, if at least two out of the plurality of contents are copy-once contents, two or more copies of these copy-once contents are inhibited from being recorded on an identical recording medium (irrespective of the identity of their contents).

Two or more copy media can be prevented from being generated from one copy-once content using a single recording apparatus.

### BRIEF DESCRIPTION OF THE SEVERAL VIEWS OF THE DRAWING

FIG. 1 is a block diagram for explaining a digital video recorder (a video apparatus for simultaneously recording a plurality of copy-protected contents according to their conditions) according to an embodiment of the present invention;

FIG. 2 is a flowchart for explaining a simultaneous video recording processing method of copy-protected contents according to an embodiment of the present invention;

FIG. 3 is a flowchart for explaining a simultaneous video recording processing method of copy-protected contents according to another embodiment of the present invention; and

FIG. 4 is a flowchart for explaining a simultaneous video recording processing method of copy-protected contents according to still another embodiment of the present invention.

### DETAILED DESCRIPTION OF THE INVENTION

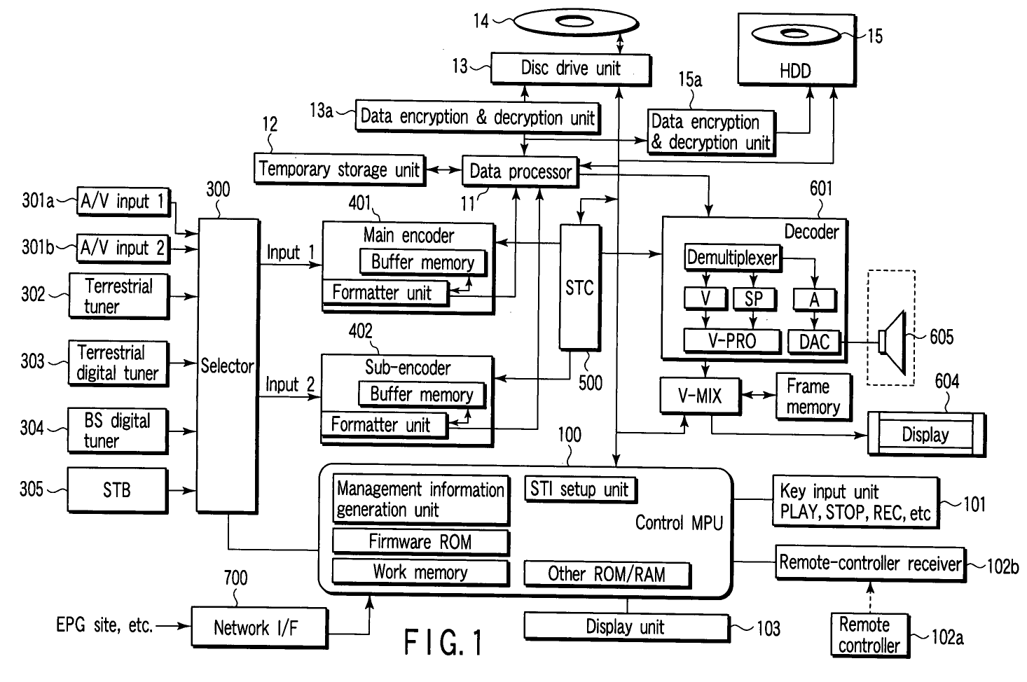

An embodiment of the present invention will be described below with reference to the accompanying drawings. FIG. 1 is a block diagram for explaining an example of an apparatus (a video apparatus for simultaneously recording a plurality of copy-protected contents according to their conditions) according to an embodiment of the present invention. This apparatus has microprocessing unit (MPU) 100, key input unit 101, remote-controller receiver 102b for receiving user operation information from remote controller 102a, display 103, and the like.

Selector 300 can receive signals from audio-video input units 301a/301b, terrestrial analog tuner 302, terrestrial digital tuner 303, BS digital tuner 304, and external tuner (set-top box: STB) 305. STB 305 is connected to a satellite antenna (not shown). STB 305 decodes received digital broadcasting data to generate an AV signal (digital), and outputs that AV signal (this output process can use signal transfer based on IEEE1394). Selector 300 can select an input stream, and can supply the selected stream to main encoder 401 and sub-encoder 402. Main encoder 401 and sub-encoder 402 convert input signals into a predetermined format (DVD standard format or similar format; e.g., DVD-VR standard format or next-generation HD-DVD standard format), and supply their outputs to data processor 11.

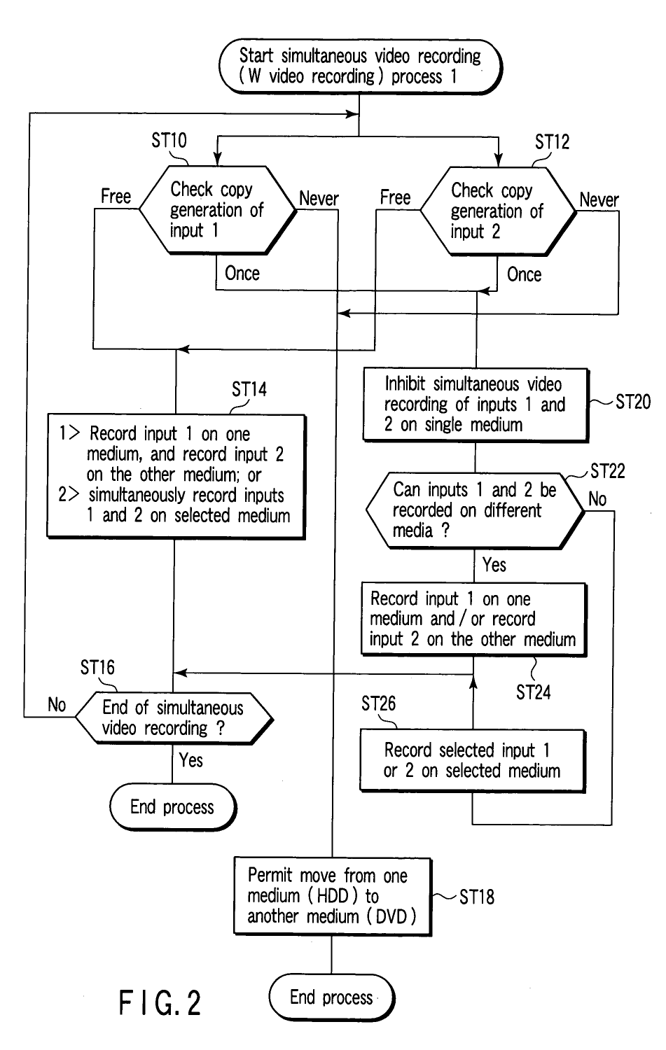

Each of encoders 401 and 402 includes an A/D converter, video encode unit, input selector to the video encode unit, audio encode unit, sub-picture encode unit, formatter unit, buffer memory, and the like. The apparatus shown in FIG. 1 has main encoder 401 and sub-encoder 402 to simultaneously obtain two encode outputs, and can record these encode outputs on information recording media (optical disc 14 and/or hard disc (HDD) unit 15). This data process will be described later with reference to the flowcharts in FIGS. 2 to 4.

MPEG-TS packet data received by STB (satellite and/or terrestrial digital tuner) 305 are converted into packet groups by the formatter units (or unit) of encoder 401 and/or encoder 402, and the packet groups are saved in the buffer memories (or memory). When the saved packet groups reach a predetermined size (for one or an integer multiple of CDA size), they are recorded on a disc or discs (14 and/or 15). As the operations to be executed at that time, upon reception of TS packets, a group is formed every 85 packets (or packets corresponding to an integer multiple of 85 packets), and a packet group header is generated.

On the other hand, an analog signal input from terrestrial tuner 303 or line input 301a/301b is converted into a digital signal by an A/D converter (not shown). That digital signal is input to respective encoders 401 and 402. In each of encoders 401 and 402, a video signal is input to a video encode unit (not shown), an audio signal is input to an audio encode unit (not shown), and text data of, e.g., teletext broadcasting is input to a sub-picture encode unit (not shown). The video signal is compressed by MPEG, the audio signal is compressed by AC-3(R) or MPEG audio (AAC encode or the like), and the text data is compressed by runlength coding.

In each of encoders 401 and 402, encoded compressed data are converted into blocks to have 2084 bytes per block and these blocks are input to the formatter unit. The formatter unit converts packets into blocks and multiplexes them to form a stream, and sends that stream to data processor 11. Data processor 11 forms ECC blocks appended with error correction data for every 16 (or 32) data blocks, and applies predetermined modulation to them. The modulated data is sent to disc drive unit 13 via data encryption & decryption unit 13a, and is also sent to hard disc drive unit 15 via data encryption & decryption unit 15a.

When disc drive unit 13 is busy due to seek, track jump, and the like, data are stored in temporary storage unit 12, and wait until disc drive unit 13 is ready. Data processor 11 can time-divisionally send data to be recorded to disc drive unit 13 and hard disc drive (HDD) 15 for respective recording data units (e.g., for respective CDA units as physical continuous recording units) under the control of MPU 100.

Each of encoders 401 and 402 includes the formatter unit, which sends the above recording data to data processor 11. Also, the formatter unit generates segmentation information during video recording, and periodically sends it to MPU 100 (GOP head interrupt or the like). The segmentation information includes the number of logical blocks (LBs) of video object unit VOBU as an access unit to a drive, the end address of I-picture data from the head of VOBU, the playback time of VOBU, and the like.

System time counter (STC) 500 counts clocks on a 27-MHz basis, and generates reference clocks of blocks of respective units of the apparatus.

Reference numeral 601 denotes a decoder. Data read from optical disc 14 and/or hard disc 15 upon playback undergo (or undergoes) amplification and error correction processes by data processor 11, and are (or is) sent to decoder 601. Decoder 601 includes a demultiplexer including a memory, a video decode unit including a reduced-scale image (thumbnail or the like) generator, a sub-picture decode unit, an audio decode unit, a TS packet transfer unit, a video processor (V-PRO) unit, an audio D/A converter, and the like. An analog output (monaural, stereo, or AAC 5.1CH surround) from the D/A converter in decoder 501 is amplified by an AV amplifier or the like (not shown) and is input to loudspeakers 605. In this case, a required number of loudspeakers are driven as needed.

In order to display contents, whose video recording is in progress, on display 604 (e.g., TV), stream data to be recorded is sent to decoder 601 simultaneously with data processor 11, and can be played back (video recording monitor). In this case, MPU 100 makes setups upon playback in decoder 601, which then automatically executes a playback process. Stream data setup information used in this case can be generated by an STI setup unit in MPU 100.

MPU 100 can be connected to the Internet via network I/F 700. MPU 100 can download electronic program guide information (EPG information) as needed from digital tuners 303 to 305 or an EPG site on the Internet. The contents of a content to be recorded can be specified based on this EPG information (broadcasting time information, broadcasting channel information, title information, other related information codes, and the like).

In the apparatus arrangement shown in FIG. 1, since both optical disc drive 13 and HDD 15 allow high-speed read/write processes, if a content to be recorded is not copy-protected (copy-free content), the following processes can be made.

(1) Recording data from encoders 401 and 402 are temporarily buffered on storage unit 12. While data of encoder 401 undergoes high-speed dubbing from storage unit 12 onto disc 14, subsequent recording data from encoder 401 is buffered on storage unit 12. During this buffering, the previously buffered data of encoder 402 undergoes high-speed dubbing from storage unit 12 onto disc 14. By alternately repeating the aforementioned processes, two contents (e.g., a broadcasting content from terrestrial analog tuner 302 and a content from line input 301a) can be simultaneously recorded on disc 14 (double or W video recording).

(2) Recording data from encoders 401 and 402 are temporarily buffered on storage unit 12. While data of encoder 401 undergoes high-speed dubbing from storage unit 12 onto HDD 15, subsequent recording data from encoder 401 is buffered on storage unit 12. During this buffering, the previously buffered data of encoder 402 undergoes high-speed dubbing from storage unit 12 onto HDD 15. By alternately repeating the aforementioned processes, two contents can be simultaneously recorded on HDD 15 (W video recording).

(3) In addition to the process of (1), data from encoder 401 or 402 can be parallel recorded on HDD 15 during simultaneous video recording on disc 14. Alternatively, when disc 14 is used up during video recording, subsequent video recording may be continued on HDD 15 (relay or relief video recording).

(4) In addition to the process of (2), data from encoder 401 or 402 can be parallel recorded on disc 14 during simultaneous video recording on HDD 15. Alternatively, when HDD 15 is used up during video recording, subsequent video recording may be continued on disc 14 (relief video recording).

(5) During video recording of data from encoder 401 (or 402) on disc 14, data from encoder 402 (or 401) is recorded on HDD 15. In this way, two contents can be simultaneously recorded oh disc 14 and HDD 15 (double video recording).

The processes of (1) to (5) can be executed without problems when contents to be recorded are not copy-protected (copy-free contents). On the other hand, if contents to be recorded are copy-never contents and their move processes are not allowed, the processes of (1) to (5) cannot be executed. However, if contents to be recorded are copy-once contents, some of the processes of (1) to (5) can be executed in consideration of their move availability conditions. The process in such case will be explained below with reference to the flowcharts.

In the following description, simultaneous video recording of two inputs 1 and 2 is assumed. Inputs 1 and 2 can be two arbitrary of sources selected by selector 300 in FIG. 1. If sources selected as input 1 and/or input 2 are contents which are not copy-controlled by CGMS (Copy Generation Management System), they are handled as copy-free contents. On the other hand, if an analog source whose copy is inhibited by, e.g., Macrovision(R) or the like, a content of that source is handled as a copy-never content.

FIG. 2 is a flowchart for explaining a simultaneous video recording processing method (W video recording process example 1) of copy-protected contents according to an embodiment of the present invention. As one of characteristic features of this processing method, two or more copies of two copy-once contents are inhibited from being recorded on a single recording medium if they have the same or different contents.

In the process shown in FIG. 2, if a simultaneous video recording (W video recording) process starts, the copy generations of inputs 1 and 2 are checked (steps ST10 and ST12). If both inputs 1 and 2 are copy-free contents, simultaneous video recording is executed by one of the following methods (step ST14). (Either of methods to be used is determined depending on user setups or default setups of an apparatus used.)

1> Input 1 (e.g., an input from terrestrial analog tuner 302) is recorded on one medium (e.g., HDD 15), and input 2 (e.g., an input from STB 305) is recorded on one medium (e.g., HDD 15); or

2> Inputs 1 and 2 are recorded on one medium (e.g., HDD 15) of user's choice.

During execution of simultaneous video recording of 1> or 2> (No in step ST16), the process in step ST14 is maintained as long as contents to be recorded are copy-free contents. Upon completion of this simultaneous video recording (Yes in step ST16), the process in FIG. 2 ends, and the control enters another mode (e.g., a pause mode of the recording apparatus). If one of inputs 1 and 2 is a copy-free content but the other is not a copy-free content, video recording of the copy-free content is done in step S14 while move video recording (or video recording inhibition) of the other content is made in step ST18 (to be described later) or video recording of this other content is executed only once in step ST26.

If it is determined in steps ST10 and ST12 that both inputs 1 and 2 are copy-never contents, video recording of contents of input 1 and/or input 2 is inhibited, thus ending the process. Or if the apparatus used supports a move function, contents of movable input 1 and/or input 2 undergo move video recording (step ST18).

For example, if the content of input 1 is a DVD-RAM playback output (movable copy-never content) from an external DVD-VR recorder, and the content of input 2 is a DVD-video playback output (unmovable copy-never content) from an external DVD-video player, video recording of input 2 is inhibited, and only the DVD-RAM playback output undergoes move video recording on, e.g., HDD 15 (in this example, even if there are two inputs, W video recording is not attained).

Or if input 1 is a playback output (movable copy-never content) from HDD 15, and the content of input 2 is a DVD-video playback output (unmovable copy-never content) from an external DVD-video player, video recording of input 2 is inhibited, and only the HDD playback output undergoes move video recording on disc 14 loaded in drive unit 13 (in this example, even if there are two inputs, W video recording is not attained).

If it is determined in steps ST10 and ST12 that both inputs 1 and 2 are copy-once contents, the contents of inputs 1 and 2 are inhibited from being simultaneously recorded on a single medium (e.g., HDD 15) (step ST20). In the process shown in FIG. 2, since the identity of the contents of inputs 1 and 2 is not checked, the contents of inputs 1 and 2 may be identical. In such case, if simultaneous video recording of inputs 1 and 2 on a single medium is permitted, two copies of a copy-once content are formed on a single medium. In this case, there is a fear of production of two copy-once contents from an apparatus (optical disc drive or HDD) that has paid copyright compensation for only one apparatus. In the process in FIG. 2, such fear is wiped out by step ST20.

After the contents of inputs 1 and 2 are inhibited from being simultaneously recorded on a single medium (e.g., HDD 15), it is checked if they can be simultaneously recorded on different media (step ST22). For example, if the apparatus that executes the process shown in FIG. 2 independently includes optical disc drive 13 and HDD 15 that have independently paid copyright compensation, inputs 1 and 2 can be independently simultaneously recorded on optical disc drive 13 and HDD 15 (Yes in step ST22). In this case, input 1 can be recorded on one medium (e.g., HDD 15), and/or input 2 can be recorded on the other medium (e.g., DVD-RAM disc 14 loaded to optical disc drive 13) (step ST24). When video recording processes of inputs 1 and 2 are parallel done, simultaneous video recording (W video recording) is attained. When one of the two media is used up and its remaining capacity becomes zero, video recording on the fully recorded medium stops, and video recording of input 1 or 2 is done for the remaining medium. The expression “and/or” in step ST24 considers such situation.

On the other hand, after the contents of inputs 1 and 2 are inhibited from being simultaneously recorded on a single medium (e.g., HDD 15), if the apparatus cannot simultaneously record the contents of inputs 1 and 2 on different media (No in step ST22) (e.g., if the apparatus has paid copyright compensation for only one apparatus as a whole), the control prompts the user to select an input to be recorded and a medium as a video recording destination via a menu or dialog (not shown), and selected input 1 or 2 is recorded on the selected medium (HDD 15 or optical disc 14) (step ST26). Alternatively, a method of recording only input 1 on HDD 15 as default setups of the apparatus if No in step ST22 may be used. (In the above example, W video recording is not attained even when there are two inputs.)

Note that the following method can also be adopted in the process of FIG. 2. That is, when the copy control attributes or attribute of copy-free or copy-once input 1 and/or input 2 have or has changed to copy never during their W video recording, the video recording process of input 1 and/or input 2 whose attribute has changed to copy never is interrupted (depending on the apparatus specification, the move process in step ST18 may be adopted in collaboration with another recording apparatus).

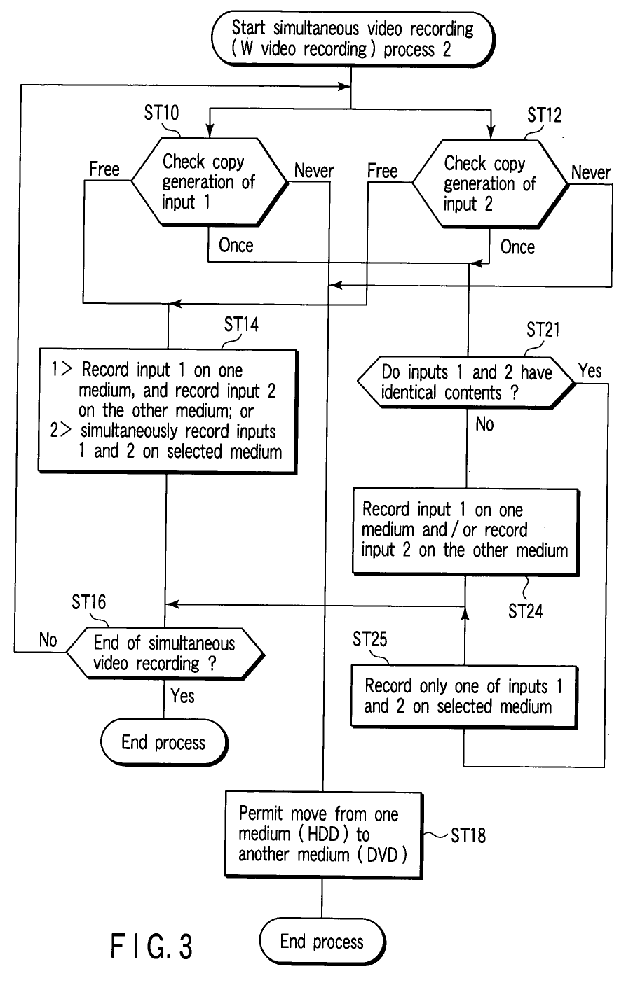

FIG. 3 is a flowchart for explaining a simultaneous video recording processing method (W video recording process example 2) of copy-protected contents according to another embodiment of the present invention. As one of characteristic features of this processing method, if there are a plurality of copy-once contents with the same contents, one of these contents is recorded. Since the process in FIG. 3 has a difference from that in FIG. 2 when the contents of inputs 1 and 2 are copy-once contents, that difference will be explained below.

That is, the identity of the contents of inputs 1 and 2 as copy-once contents is checked (step ST21). For example, if input 1 is a copy-once content of terrestrial digital broadcasting and input 2 is that of BS digital broadcasting, the identity can be checked by comparing EPG information (broadcasting channel, broadcasting time, program title, keyword identifier, decoding/expansion process information, etc.; or given byte data from the head of a code sequence of EPG information itself described in the same format) of input 1 with that of input 2. If no such identity check information is available, and it cannot be determined if the contents of inputs 1 and 2 are identical, it is determined (estimated) that inputs 1 and 2 have the same contents.

If it is determined (estimated) that inputs 1 and 2 have the same contents (Yes in step ST21), the control prompts the user to select an input to be recorded and a medium as a video recording destination via a menu or dialog (not shown), and selected input 1 or 2 is recorded on the selected medium (HDD 15 or optical disc 14) (step ST25). Alternatively, a method of recording only input 1 on HDD 15 as default setups of the apparatus if Yes in step ST21 may be used. (In the above example, W video recording is not attained even when there are two inputs.)

On the other hand, if it is determined that inputs 1 and 2 have different contents (No in step ST21), input 1 is recorded on one medium (e.g., HDD 15), and/or input 2 is recorded on the other medium (e.g., DVD-RAM disc 14 loaded to optical disc drive 13) (step ST24).

If the apparatus that executes the process in FIG. 3 has a specification that can simultaneously record contents if one or both of two contents to be recorded are copy-free contents but cannot simultaneously record two copy-once contents, one of inputs 1 and 2 is recorded in step ST24.

According to the process shown in FIG. 3, two copies of two copy-once contents with the same contents can be prevented from being recorded on a single medium by the checking process in step ST21 and the process in step ST25.

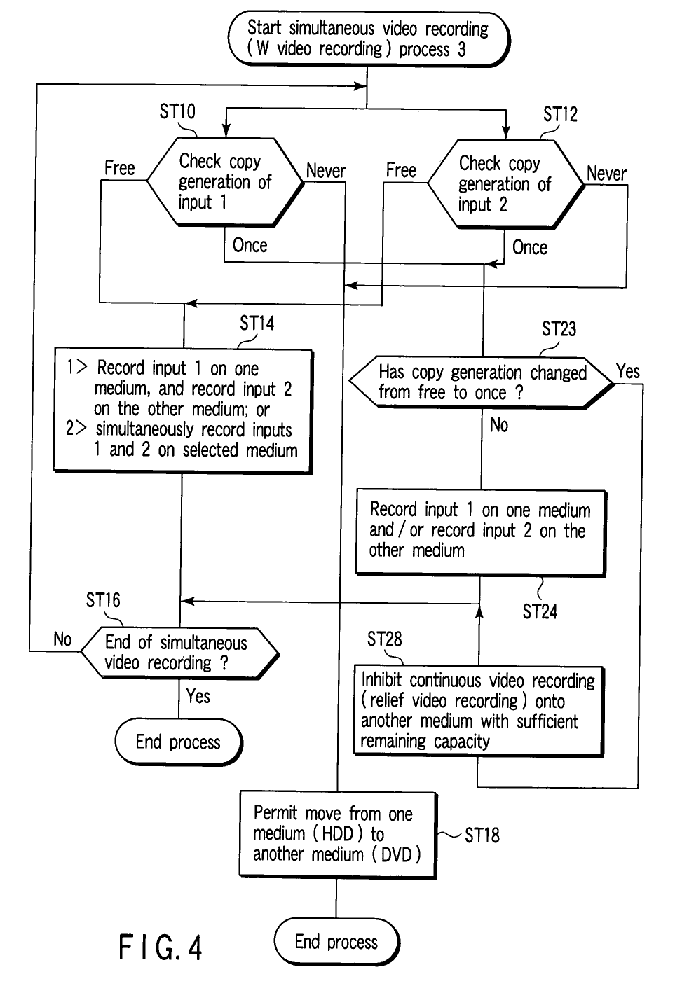

FIG. 4 is a flowchart for explaining a simultaneous video recording processing method (W video recording process example 3) of copy-protected contents according to still another embodiment of the present invention. As one of characteristic features of this processing method, if one of a plurality of contents whose W video recording is in progress has changed from a copy-free content to a copy-once content, continuous video recording by changing a medium as a video recording destination is inhibited. Since the process in FIG. 4 mainly has a difference from FIG. 2 in the process when contents of inputs 1 and 2 are copy-once contents, only the difference will be explained below.

During execution (2> in step ST14) of simultaneous video recording (W video recording) of two contents of inputs 1 and 2 (both of which are copy-free contents) onto a single medium, if the copy generation management information of the content of input 1 or 2 has changed to copy once (Yes in step ST23), and if the medium which is currently used in video recording is used up during that video recording, relief video recording that continues simultaneous video recording including the content which has changed to the copy-once content to another medium is inhibited (step ST28).

Assume that both inputs 1 and 2 are copy-free broadcasting contents at the beginning of video recording, inputs 1 and 2 are simultaneously recorded on HDD 15 (2> in step ST14), and DVD-RAM disc 14 which has a recordable remaining capacity is loaded to disc drive 13. Also, assume that one of inputs 1 and 2 has changed from a copy-free program to a copy-once program (Yes in step ST23). In this case, if HDD 15 is used up and the remaining part of the program undergoes relief video recording on DVD-RAM disc 14, the contents of the identical copy-once program may remain recorded on HDD 15 and DVD-RAM disc 14. For example, if that copy-once content is a music program including a plurality of tunes, some former tunes of that program may remain recorded on HDD 15, and some latter tunes may remain recorded on DVD-RAM disc 14. This results in that two video recording media can be produced from one program as a copy-once content using a single recording apparatus.

Note that the following embodiment is also available. That is, even when an identical copy-once program is to be recorded on a given medium (e.g., HDD 15) and the other medium (e.g., DVD-RAM disc 14), if they have different video recording contents (in the above example, some former tunes of the music program are different from some latter tunes), relief video recording in step ST28 is permitted.

A program that implements the aforementioned processing method can be stored in a firmware ROM in MPU 100 in FIG. 1. A work memory in MPU 100 can be used as a work area used upon execution of this program. Furthermore, a ROM/RAM in MPU 100 can be used as needed upon execution of this program. For example, EPG data downloaded from a digital tuner or an EPG site on the Internet can be stored in the RAM in MPU 100. Also, information (logo, icon, or the like indicating a station) of each broadcasting station, which is known in advance, can be stored in the ROM in MPU 100.

### SUMMARY

The present invention can be practiced as various embodiments, and the following specification of a product upon practicing the present invention is available as one example.

01) If there are two copy-once sources, they are not simultaneously recorded on an HDD independently of their identity of contents (step ST20 in FIG. 2).

02) If the attribute of one of sources whose simultaneous video recording (W video recording) is in progress has changed from copy free to copy once, relief video recording from the HDD to an optical disc (DVD-RAM, DVD-RW, or the like) is inhibited (step ST28 in FIG. 4).

03) If there are two copy-once sources, simultaneous video recording of them on the HDD and optical disc (DVD-RAM, DVD-RW, or the like) for one content each is permitted (step ST24 in FIG. 2 or 3) (for example, during video recording of an Olympic program on the HDD, a music program in the same broadcasting time band can be simultaneously recorded on the DVD-RAM disc).

04) Copy-once contents which are recorded on the HDD and optical disc (DVD-RAM, DVD-RW, or the like) (after video recording, their attributes have changed to copy never) can be dubbed by a move function (step ST18 in FIGS. 2 to 4). Note that the move direction can be limited to one direction, i.e., from the HDD to the optical disc.

The following specification of a product upon practicing the present invention is available as another example.

11) If there are two copy-once sources, they can be simultaneously recorded on an HDD, but the content that can be moved is limited to one of them or both the contents are inhibited from being moved (in such case, only playback or erase is allowed).

12) Even when the attribute of one of sources whose simultaneous video recording (W video recording) is in progress has changed from copy free to copy once, relief video recording from the HDD to an optical disc (DVD-RAM, DVD-RW, or the like) is allowed. (However, the move function can be limited to prevent two or more optical discs from being produced from an identical copy-once content using an identical apparatus. Whether or not an identical apparatus is used can be determined with reference to the description contents of manufacturer information area MNFI of the apparatus in management information recorded on a disc according to the DVD-VR standard.)

13) If there are two copy-once sources, simultaneous video recording of them on the HDD and optical disc (DVD-RAM, DVD-RW, or the like) for one content each is inhibited (this simultaneous video recording is permitted if one of these sources is a copy-free content).

14) Copy-once contents which are recorded on the HDD and optical disc (DVD-RAM, DVD-RW, or the like) or vice versa (after video recording, their attributes have changed to copy never) can be dubbed by a move function (step ST18 in FIGS. 2 to 4). (However, caution must be exercised not to produce two or more optical discs with the same contents from an identical copy-once content as needed.)

Note that the present invention is not limited to the aforementioned embodiments themselves, and can be embodied by variously modifying required constituent elements without departing from the scope of the invention when it is practiced. For example, the embodiment of FIG. 1 exemplifies a 2-encoder/2-drive arrangement that allows simultaneous video recording of two programs. Based on the same concept, the present invention can be developed to an N-encoder/M-drive arrangement (for example, a 4-encoder/3-drive arrangement or a 4-encoder/4-drive arrangement in effect by connecting two apparatuses with the 2-encoder/2-drive arrangement via the network). The processing methods shown in FIGS. 2 to 4 assume simultaneous video recording of two inputs 1 and 2. However, depending on the arrangement of a recording apparatus used, simultaneous video recording of three or more inputs may be made. Further, a semiconductor memory device may be used for the recording medium.

Also, various inventions can be formed by appropriately combining a plurality of required constituent elements disclosed in the embodiment. For example, some required constituent elements may be deleted from all the required constituent elements disclosed in the embodiment. Furthermore, required constituent elements according to different embodiments may be combined as needed.

1. A method for simultaneously recording one or more identical or different contents on one or more recording mediums by an audio-visual apparatus having a simultaneous recording function for the contents, said method comprising:
checking if each of the contents is copy-protected; and
starting, if none of the plurality of contents is copy-protected, simultaneous recording of the contents.

2. An apparatus for simultaneously recording one or more identical or different contents on one or more recording mediums, comprising:
at least one record unit configured to be able to simultaneously record the contents on at least one of the recording mediums; and
a control unit configured to check whether each of the contents is copy-protected, and configured to start simultaneous recording of the contents using the at least one record unit when none of the contents is copy-protected.

3. A computer-readable program to be executed by a computer, said computer-readable program being provided for simultaneously recording one or more identical or different contents on one or more recording mediums, said computer-readable program comprising:
a first portion configured to check if each of the contents is copy-protected; and
a second portion configured to start, if none of the plurality of contents is copy-protected, simultaneous recording of the contents.

4. The method of claim 1, further comprising:
inhibiting, if at least two of the contents are copy-once contents, at least two of these copy-once contents from being recorded on an identical one of the recording mediums.

5. The method of claim 1, further comprising:
checking, if at least two out of the plurality of contents are copy-once contents, whether the copy-once contents have identical contents; and
executing, if the copy-once contents have identical contents, recording of one of these identical contents.

6. The method of claim 1, further comprising:
executing, if all of the contents are copy-free contents, simultaneous recording of the contents on the first recording medium; and
inhibiting, if one of the contents has changed from a copy-free state to a copy-once state during recording on the first recording medium, recording of the one content on the second recording medium.

7. The apparatus of claim 2, further comprising:
an inhibition unit configured to, when at least two out of the contents are copy-once contents, inhibit these two copy-once contents from being recorded on an identical one of the recording mediums.

8. The apparatus of claim 2, further comprising:
a second control unit configured to check whether each of the contents is copy-protected, and configured to execute simultaneous recording of the contents using the one record unit when none of the contents is copy-protected; and
a third control unit configured to, when each of the contents is a copy-once content, check whether these contents have identical contents, and configured to execute recording of one of these identical contents if each of the contents is a copy-once content and these contents have identical contents.

9. The apparatus of claim 2, further comprising:
an inhibition unit configured to, when one of the contents has changed from a copy-free state to a copy-once state during recording on the first recording medium, inhibit recording of the one content on the second recording medium.

10. The computer-readable program of claim 3, further comprising:
a third portion configured to inhibit, if at least two of the contents are copy-once contents, at least two of these copy-once contents from being recorded on an identical one of the recording mediums.

11. The computer-readable program of claim 3, further comprising:
a third portion configured to check, if at least two out of the contents are copy-once contents, whether the copy-once contents have identical contents; and
a fourth portion configured to execute, if the copy-once contents have identical contents, recording of one of these identical contents.

12. The computer-readable program of claim 3, further comprising:
a third portion configured to execute, if all of the contents are copy-free contents, simultaneous recording of the contents on the first recording medium; and
a fourth portion configured to inhibit, if one of the contents has changed from a copy-free state to a copy-once state during recording on the first recording medium, recording of the one content on the second recording medium.
